(19) United States
(12) Patent Application Publication
(10) Pub. No.: US 2021/0055245 A1
(43) Pub. Date: Feb. 25, 2021

(54) INSULATIVE AND CONDUCTIVE COATINGS FOR MONITORING STRUCTURES AND SUBSTRATES IN ONSHORE, OFFSHORE AND SUBSEA APPLICATIONS

(71) Applicant: IMEC Partners LLC, Warminster, PA (US)

(72) Inventors: Joseph Solona, Doylestown, PA (US); Michael John Grover, Cranbrook (GB)

(21) Appl. No.: 16/999,968

(22) Filed: Aug. 21, 2020

Related U.S. Application Data
(60) Provisional application No. 62/889,652, filed on Aug. 21, 2019.

(51) Int. Cl. G01N 27/20

(52) U.S. Cl. CPC G01N 27/205

(57) ABSTRACT

Determining integrity of an insulative protective layer on a structure as an indication of damage to the structure. Applying conductive layer on the insulative protective layer and mounting electrical or electronic monitoring equipment to the structure and the conductive layer to capture different measurements and determine integrity of insulative layer and other parameters. The insulative protective may a polymer powder that is flame spayed onto the structures. The insulating layer may be applied directly to the structure or may be applied to an epoxy layer, possibly while the epoxy layer is still tacky so that the layers blend together. The conductive layer may be a metallic layer that may be metal sprayed. Multiple insulating and conductive layers may be utilized, and measurements may be taken between or within different layers.

### BACKGROUND

Structures (static and floating), vessels, tanks, substrates, infrastructure and cables are utilized to transmit material (e.g., water, oil, gas, electricity) over various distances (e.g., offshore to onshore, onshore to networks, networks to utility users). The structures and infrastructure of networks may be made of various materials (e.g., metal, composite, concrete). The integrity of the structures and infrastructure is important to continue the transmission of the material and safety of associated operations. As corrosion, for example caused by external and internal elements, is one of the factors that effects the integrity of the structures and infrastructure, the structures and infrastructure is often coated with a protective layer.

Monitoring the integrity of the structures and infrastructure may require visual inspections or other tests to determine if there are any issues with the structures and infrastructure. If the structures and infrastructure is located within a harsh environment, visual inspections may be difficult and require extensive labor and cost (e.g., access or expose the structures and infrastructure). What is needed is a way to check the integrity of the structures and infrastructure that is easy, can be done remotely and does not require the structures and infrastructure to be manually inspected.

### DETAILED DESCRIPTION

The current invention is a method for applying alternating layers of conductive and insulating coatings and sensors to the structures and infrastructure that can determine the integrity of the protective layer that is often located over the surface of the structures and infrastructure. Faults in the protective layer may be an indication that the structures and infrastructure will be suspectable to, for example, corrosion or may be an indication that there is an issue with the structures and infrastructure (e.g., corrosion, damage) that has led to faults in the protective layer.

By way of example, the structures and infrastructure may be made of a conductive material (e.g., metal) and the protective coating may be an insulating layer (insulating protective layer). In such a case, a conductive layer could then be provided over the insulating protective layer. The resistance between the conductive structures and infrastructure and the conductive layer may then be measured to determine if the insulating protective coating retains integrity. If the insulating protective layer retained integrity (was a complete layer) the two conductive layers would not be electrically or electronically connected (e.g., open circuit) and the resistance between the conductive layers would be high (e.g., infinity). However, if the insulating protective layer was compromised in some fashion (e.g., warn, eroded, gouged, cracked), a low resistance path between the conductive layers could potentially be formed and the two conductive layers could potentially be electrically or electronically connected. If a path is formed between the conductive layers, the resistance therebetween may decrease while if the two conductive layers are connected (e.g., short circuit) the resistance between the conductive layers may be low (e.g., zero).

In order to measure the resistance, electrical or electronic monitoring equipment may be mounted to the structures and infrastructure structures as well as the conductive layer and some type of measurement device (e.g., processor, sensor) may be connected to each of the layers in order to measure resistance. The measurement device may include wireless capability so that it may be accessed remotely. The remote access may be continuous, at defined intervals of time or on demand. The remote access may be via a computer. The computer may be part of a monitoring system for the structures and infrastructure line. The monitoring system may be capable of taking further actions if a determination is made that the insulating protective layer is compromised in some fashion.

The insulating protective layer may be any number of materials and may be applied in various fashions. For example, the insulating protective layer may be a polymer powder that is flame spayed onto the structures and infrastructure. Alternatively, the protective layer may be a liquid polymer that is applied to the structures and infrastructure, for example, via rolling or spraying. The insulating protective layer may be applied directly to the structures and infrastructure or may be applied to, for example, an epoxy layer that is applied to the pipe. According to one embodiment, the protective insulating layer may be applied while the epoxy layer is still tacky so that the layers blend together to form a single layer. The conductive layer may be a metallic layer that is applied onto the insulating protective layer. According to one embodiment, the conductive layer may be metal sprayed onto the insulating protective layer. However, the conductive layer is not limited to being metal sprayed and can be applied by other means without departing the current scope.

If the structures and infrastructure were made of a non-conductive material, a conductive layer could be applied to the structures and infrastructure prior to the insulating protective layer being applied so that the resistance can be measured between the two conductive layers. The various coatings may be applied to the structures and infrastructure prior to the structures and infrastructure being installed (e.g., factory applied). In the field where the structures and infrastructure are being installed, the coatings could be added to locations where the structures and infrastructure are connected. If any of the various layers is damaged in the field, the layers could be fixed in the field. Breaks in the upper conductive layer could be created to define the portions of the structures and infrastructure that may be measured, and monitoring equipment may be located in each of the sections.

In the field, a protective layer may be placed over all the layers to provide protection for the conductive layer. The protective layer may be various types of layers that may be applied in various different manners and is subject to application and environmental conditions.

The invention has been described as a conductive layer being provided on top of an insulating protective layer that is applied on top of structures and infrastructure made of various materials. However, the invention is not limited thereto. Rather, multiple alternating conductive and insulating layers could be utilized with each of the conductive layers could include sensors and the sensors may be connected to measurement devices to determine the resistance between the layers and thus the integrity of the insulating protective layers.

Furthermore, the invention has been described with respect to measuring resistance between conductive layers but is not limited thereto. Rather, other electrical parameters, sensor signals, temperature, pressure and other physical parameters could be measured between or within the various layers.

Furthermore, the invention is described above with respect to structures and infrastructure made but is not limited thereto. Rather it could be applied to any substrate.

1. A method for monitoring a protective layer over a substrate, the method comprising
applying an insulating protective layer on a substrate;
applying a conductive layer on the insulating protective layer; and
measuring electrical and electronic parameters between the substrate and the conductive layer, wherein the electrical and electronic parameters measurement will provide an indication of health of the insulating protective layer.

2. The method of claim 1, wherein the substrate is conductive.

3. The method of claim 2, further comprising
mounting a first sensor to the substrate; and
mounting a second sensor to the conductive layer, wherein the measuring electrical and electronic parameters includes connecting to at least one of the first and the second sensors.

4. The method of claim 1, further comprising providing a protective insulating layer of the conductive layer.

5. The method of claim 1, wherein the applying the insulating protective layer includes flame spraying a polymer powder.

6. The method of claim 1, wherein the applying the insulating protective layer includes
applying an epoxy layer; and
flame spraying a polymer powder onto the epoxy layer.

7. The method of claim 1, wherein the flame spraying a polymer powder onto the epoxy layer includes flame spraying the polymer powder onto the epoxy layer before the epoxy layer cures so that the polymer powder is imbedded into the epoxy layer.

8. The method of claim 1, wherein the applying the insulating protective layer includes applying a liquid polymer.

9. The method of claim 1, wherein the applying the conductive layer includes metal spraying a metal layer.

10. The method of claim 1, wherein the substrate is non-conductive and further comprising applying an initial conductive layer to the substrate prior to applying the insulating protective layer.

11. The method of claim 10, further comprising
mounting a first sensor to the initial conductive layer; and
mounting a second sensor to the conductive layer, wherein the measuring electrical and electronic parameters includes connecting to the first sensor and the second sensor.

12. The method of claim 1, wherein the substrate is a pipe.

13. The method of claim 1, wherein the substrate is a bridge.

14. The method of claim 1, wherein the substrate is a tank.

15. The method of claim 1, wherein the substrate is a vessel.

16. The method of claim 1, wherein the substrate is a structure.

17. The method of claim 1, further comprising applying additional insulating and conductive layers.

18. The method of claim 17, further comprising
mounting additional sensors to various ones of the additional insulating and conductive layers, wherein the measuring electrical and electronic parameters includes connecting to at least a subset of the additional sensors.
